(19) United States
(12) Patent Application Publication
(10) Pub. No.: US 2022/0335015 A1
(43) Pub. Date: Oct. 20, 2022

(54) OPTIMIZED RESOURCE PACKAGING FOR RESOURCE-BOUND DELIVERY AND CONSUMER DEVICES

(71) Applicant: Signal infrastructure Group, Boulder, CO (US)

(72) Inventor: Azita Manson, Mountain View, CA (US)

(73) Assignee: Signal infrastructure Group, Boulder, CO (US)

(21) Appl. No.: 17/722,170

(22) Filed: Apr. 15, 2022

Related U.S. Application Data
(60) Provisional application No. 63/176,728, filed on Apr. 19, 2021.

(51) Int. Cl. G06F 16/185; G06F 16/16; G06F 16/13

(52) U.S. Cl. CPC G06F 16/185; G06F 16/164; G06F 16/137

(57) ABSTRACT

Described embodiments provide for a method for communicating a file hierarchy system using metadata files. The method can include identifying a directory hierarchy of sub-directories with resources. The method can include generating a starting metadata file describing user credential information and an ordered list of unique children identifiers to identify each of the metadata files for describing the sub-directories. The method can include generating metadata files for each of the sub-directories corresponding to at least the unique child identifiers of the starting metadata file, the metadata files describing a name of the sub-directory, resources stored in the sub-directory, and a parent identifier identifying the name of the starting metadata file. The method can include transmitting the starting metadata file and the metadata files to cause a second device to create the directory hierarchy using metadata from the starting metadata file and the metadata files.

### RELATED APPLICATIONS

This patent application claims the benefit of and priority to U.S. Provisional Patent Application No. 63/176,728 titled “OPTIMIZED RESOURCE PACKAGING FOR RESOURCE-BOUND DELIVERY AND CONSUMER DEVICES,” and filed Apr. 19, 2020, the contents of all of which are hereby incorporated herein by reference in its entirety for all purposes

### FIELD OF THE DISCLOSURE

The present application generally relates to sharing and communicating resources and organization and grouping structures. In particular, the present application relates to systems and methods for more efficiently packaging and communicating resources and a file hierarchy over a network or communicating between two systems agnostics to the delivery mechanism protocols.

### BACKGROUND

A system may share files with another system via a network delivery through directory structure, where the directory names are fixed strings and are in inefficient form for hierarchy organization of resources, when traveling across different physical medium deliveries and protocols. The existing delivery protocols such as gzip, multipart mime type, FLUTE depends on a single string describing the relationship between the resources.

### BRIEF SUMMARY

File sharing implementations can rely on organizing the resources in a hierarchy of directory structures, where the resources are static objects tied permanently to a directory structure and directories are permanently connected together in a static hierarchy organization. Any changes to the organizations or resources can cause the entire set of information to be re-delivered, which can be inefficient in resource-bound networks and delivery systems. In these file sharing mechanisms, the information that ties resources can be strings organized in a particular format. For example, /abc/cde/edf/xyz.png file is considered a different file from /edf/xyz.png file. It can be difficult to provide the hierarchy metadata associated with each resource without tying them to specific file name or directory naming conventions. The delivery protocols such as FLUTE and ROUTE can tie the file names and directory as the only identifying information about the file.

Existing delivery systems may treat resources as static objects, and since the delivery system may rely on using known file formats as mime types, then only these physical mime types may be delivered and thus only known resource files may be delivered. However, the protocol may not be able to include additional metadata describing each file other than their file format (e.g. image, pdf, mp4). For example, the protocol may include a directory name or hierarchy built into the resource filename without any additional information. In a cable system, a directory hierarchy can be delivered over a known file name, but the delivery may need to complete before the receiving devices are able to reconstruct the directory hierarchy. For example, a directory hierarchy may not be presented unless at least one file is presented and fully downloaded, where the file name includes the directory name. Therefore, depending on the file size and reliability of the one-way delivery system, there may be one or more cycles before a physical resource can be fully downloaded and presented.

The file structure may also lose its ordering (e.g., delivered out of order, at different times, etc.) during delivery. Without additional information to describe the ordering of the files and directories, the receiver of the files may be unable to establish or rebuild a hierarchy of the directories and file names, nor is there a mechanism to create personalized files based on user credentials.

Even with a pre-established file hierarchy, when the name of a directory is combined with file names, then all the resources must be considered as new resources and downloaded again whenever the directory name changes. Similarly, managing the lifecycle of existing resources and files may be based on assigning an expiration to each file. However, managing expiration times can be a complicated balancing act between picking expiration times that cause the files to exist longer than necessary and expiration times that cause the files to be downloaded more frequently than necessary. Accordingly, the aforementioned file sharing implementations may be unable to efficiently share the directory structure.

To account for these and other challenges, a file hierarchy can be shared using metadata files. A resource packager can package information associated with the resources and directories into metadata files having objects with a set of attributes. The metadata information can include hierarchy information such as folder structure, physical resource file location, metadata describing hierarchy, or lifecycle information (which can be updated independent of the physical resources itself). The objects may include attributes associated with the hierarchy information such as alphanumeric directory names, but also include color-coding of folders, font, tags, versioning, file extension, and other information to improve the presentation of files shared with a variety of applications and services.

Each object can have a globally unique identifier and a set of attributes. The attributes provide information about the inter-relationships between the objects, the order of the metadata relative to one another, additional presentation layer information, and other embedded security protocols. The resource packager organizes the objects in a flat organization identified by the unique identifier. Therefore, the objects can be independent of any underlying naming protocols or naming convention for directories, and hence delivered in a more efficient manner. The objects can also be independent of the physical resources such that a file manager can hide physical resources without affecting the objects forming the directory hierarchy. For example, a 360-view map or photo file may include more information than just one physical resource that is visible.

A resource packager can encrypt or sign the metadata file to avoid tampering. To avoid tampering and hacking, the resource packager can also obfuscate information stored by the objects by changing the easy-to-read text information into either binary format or changing the fields into unique identifiers such that it is harder to decipher different attributes and fields that may only be readable by programs. By obfuscating the hierarchy, unauthorized third parties may be unable to understand the organization or hierarchy of the resources. Additionally, the resource packager can remove information from the physical resource name to obfuscate the nature of the physical resources. For example, the objects can include a file extension of a file, so the file manager can remove the file extension from the stored resources. Storing sensitive information in a secure metadata file can add an additional layer of security since unauthorized entities may be unable to inspect and detect the file formats of various resources.

In order to navigate to the root of the hierarchy organization, one of the metadata files is designated as a starting point metadata file. The starting metadata file can include a set of objects that can describe personalized metadata associated with each user. In some embodiments, the starting metadata files makes available to a user only the objects with personalized metadata associated with that particular user. Each personalized metadata can then point to other objects used by that user at a hierarchy level designed by the originators. For example, the starting metadata file can include objects corresponding to a user login and credentials, and an ordered list of additional objects that are applicable to the user login and credential. The starting metadata file may also correspond to root directories that remain constant over time while additional metadata files can correspond to additional directories and files added to a file system or directory hierarchy. Since the starting metadata file does not need to describe the entire hierarchy structure in one file, the hierarchy can change without affecting the root directory described by the starting metadata file. For example, an educational hierarchy can include a student taking a set of classes, where over the course of the school year, the changes in the classes are infrequent and hence the corresponding files do not have to change over time. However, the lessons and materials of each class may change over time.

The additional metadata files can correspond to directories, sub-directories, files, resources, and documents. These additional metadata files can allow for a recursive directory hierarchy. For example, an additional metadata file can be the child identified in the starting metadata file and the additional metadata file can reference the starting metadata file as a parent. The metadata file can also reference a document by including metadata corresponding to the name, type, and resource associated with the document. An ordering of the identified children within each metadata file can indicate the ordering of the folders or documents within a folder.

The resource packager can share the starting metadata file and the additional metadata files with another system. The metadata files can have a small data size such that multiple metadata files can fit in a transmission chunk for faster identification of the objects with the attributes for the recreation of the directory hierarchy. The receiving system can receive the metadata files out of order. For example, the receiving system can first receive metadata files corresponding to resources and then receive a starting metadata file corresponding to a directory for those resources. However, the receiving system can then use the information stored by the metadata files to reconstruct the directory hierarchy that includes the directory identified by the starting metadata file storing the resources identified by the metadata files.

The metadata files can also change over time based on metadata versioning. The version can define whether the content of the metadata file has changed and hence whether information needs to be reloaded for the directory hierarchy. For example, since the name of a directory is an attribute of the object, changing the name does not affect the hierarchy of the design nor necessitate re-delivery of resources. Instead, the resource packager can update the object corresponding to the name. Metadata can also include a schema versioning, where the format of the attributes and names can change over time as other attributes are deemed necessary to be included. For example, the attribute may be changed to accept a new format of how to interpret a new resource file. Similarly, the hierarchy between parent and child, the user credentials, and other attributes can be changed, modified, or updated over time. However, if a metadata file is lost or corrupted, only the visibility of the metadata file's children rather than the entire directory hierarchy is affected. Since the resources and their contents can also change over time, the metadata versioning makes the metadata files compatible with these types of resources. Moreover, file systems can rely on metadata files instead of expiration times to delete resources. Metadata attributes may additionally include information about the lifecycle of the resource. The lifecycle could be extended to beyond an expiration date where it is included in other protocols. The lifecycle may include a cyclical nature of availability of a resource for a period of time or include times that are set in the future. This allows the receiving application to know when the data can be presented. For example, once a new hierarchy arrives, if a resource that previously was present is no longer accessible through the recursive object hierarchy, then the file manager can delete the resource.

The sharing of file hierarchies via metadata files may allow for the mixing of protocol layers, wherein each layer can serve a different purpose. As such, using metadata files may allow for efficient sharing of hierarchies without having to change the underlying delivery protocols. For example, the application service does not need to adjust when there are any physical delivery changes between mechanisms such as cable delivery, ATSC 3.0 broadcast delivery, ATSC 1.0 datacasting, and Broadband (Internet). As such, one layer may be for the delivery of resources, and the metadata files may establish a hierarchy or relationship between these resources. Additionally, by separating the delivery of the hierarchy and the resources, the delivery mechanism can interface with any physical delivery system file system while maintaining a meaningful hierarchy structure for an application service.

In at least one aspect, the present disclosure can include a method for communicating a set of resources among multiple systems by separating the physical resources from the metadata describing the resources. In some embodiments, the metadata contains attributes about a resource, their relationship with other resources (e.g. in a hierarchy organization), and complimentary or accompanying information or resources (e.g. a thumbnail associated with a file). In some embodiments, the method provides a starting point metadata file which can be targeted based on the user credential, device type, or other external characteristics of the outbound (from where the resources and metadata are originated) or inbound systems (where the resources and metadata is consumed). In some embodiments, the method provides the ability to obfuscate the starting point metadata file name by encrypting or creating a hash of the file name based on a common known method across the two systems. In some embodiments, the method provides a set of attributes describing the resource (beyond a mime type extension and directory name). In some embodiments, the method provides and information about a resource relationship with other resources (e.g. in a hierarchy relationship), while it is not limiting it to a specific ‘traditional’ hierarchy relationship; for example, a resource can appear inside multiple subdirectories without the need to duplicate the resource itself (this concept in some operating systems known as linking the files or shortcuts).

In some embodiments, method can provide the ability to connect the resource with other resources in a particular hierarchy regardless of the arrival delivery order of the physical resource. The ordering is not forced by an alphabetical or arrival date timestamp. It can be organized specifically by the order dictated by the originator. In some embodiments, the method provides an independent hierarchy layer from the operating systems or delivery protocols, where traditionally, there is a tight coupling of the organization of the resources and the hierarchy information. In some embodiments, the method provides the ability to obfuscate, sign, or encrypt either the resources or the metadata associated with each resource independent of one another, depending on the desired security level. In some embodiments, the method provides the ability to traverse up (to the parent node) or down (to the children nodes) from any given point quickly and efficiently by creating a bi-directional information in each node. In some embodiments, the method provides the ability to manage the lifecycle of each resource or metadata independent of other resources and update without forcing the retransmission of the entire resource itself (since the hierarchy information has been decoupled from the resource itself) In some embodiments, the method provides the ability to provide cyclical availability time window independent of the resource files and can be updated over time without retransmission of the resource itself.

In some embodiments, the method provides the ability to provide attributes describing the appearance of the resource based on types and other criteria set by the originating system. In some embodiments, the method provides ability to connect other variations of the resource such as different resolution or formats of the same resource. In some embodiments, the method provides ability to connect accompanying resources such as a thumbnail, icon, logo to represent the resource in a short form. In some embodiments, the method provides ability to provide accompanying code to play or present the resource to the consuming device. In some embodiments, the method provides the information about the resource itself such as mime type without tying it directly to the file name and the file name extensions. In some embodiments, the method provides the ability to protect content by additional security means such as password or connecting to an external encryption mechanism (e.g. source of the license server).

In another aspect the present disclosure can include a method for communicating a file hierarchy using metadata. The method can include identifying, by a resource packager of a device, a directory hierarchy of one or more sub-directories with one or more resources. The method can include generating, by the resource packager, for the directory hierarchy, a starting metadata file describing user credential information and an ordered list of one or more unique children identifiers to identify one or more the metadata files for describing the one or more sub-directories. The method can include generating, by the resource packager, the one or more metadata files for each of the one or more sub-directories corresponding to at least the unique child identifiers of the starting metadata file. The one or more metadata files can describe a name of the sub-directory, one or more resources stored in the sub-directory, and a parent identifier identifying the name of the starting metadata file. The method can include transmitting, by the device, the starting metadata file and the one or more metadata files to a second device to cause the second device to create the directory hierarchy using objects from the starting metadata file and the one or more metadata files.

In some embodiments, the method can include generating, by the resource packager, the one or more metadata files to identify a second ordered list of one or more uniquely identified children directories to the sub-directory. In some embodiments, the method can include generating, by the resource packager, the at least one unique child identifier for each file name of the one or more resources. In some embodiments, the method can include transmitting, by the device, the directory hierarchy via a plurality of metadata files. In some embodiments, the method can include encrypting, by the resource packager, the starting metadata file with a hash. In some embodiments, the method can include generating, by the resource packager, the one or more objects to identify a file extension for each of the one or more resources. In some embodiments, the method can include removing, by the resource packager, the file extension from each of the one or more resources. In some embodiments, the method can include transmitting, by the device to the second device, the one or more resources without the file extension.

In another aspect, the present disclosure can include a method for receiving a file hierarchy using metadata. The method can include receiving, by a device from a second device, a starting metadata file and one or more metadata files. The method can include identifying, by a resource receiver of the device, from the starting metadata file, user credential information and an ordered list of one or more unique children identifiers corresponding to each of the one or more metadata files describing one or more sub-directories. The method can include identifying, by the resource receiver, from one or more objects of the one or more metadata files, a parent identifier identifying the starting metadata file and the one or more sub-directories. The one or more sub-directories can order one or more resources stored in the one or more sub-directories. The method can include identifying, by the resource receiver, a directory hierarchy of the one or more sub-directories with the one or more resources. The method can include generating, by the resource receiver, the directory hierarchy using metadata from the starting metadata file and the one or more metadata files.

In some embodiments, the method can include generating, by the resource receiver, a user interface to display the one or more sub-directories of the directory hierarchy. In certain embodiments, the method can include displaying, by the resource receiver, in the user interface, the one or more resources stored in the sub-directory based on the ordered list.

In certain embodiments, the method can include receiving, by the device, a second set of one or more metadata files. In certain embodiments, the method can include identifying, by the resource receiver, from the second set of one or more metadata files, a second set of one or more sub-directories based on a second set of unique child identifiers of the second set of one or more metadata files. The second set of one or more sub-directories can order one or more resources stored in the second set of one or more sub-directories. In certain embodiments, the method can include displaying, by the resource receiver, in the user interface, the second set of the one or more sub-directories.

In some embodiments, the method can include identifying, by the resource receiver, from the one or more objects of the one or more metadata files, a second ordered list of one or more unique identifiers of children directories to the sub-directory. In some embodiments, the method can include identifying, by the resource receiver, from the one or more objects of the one or more metadata files, a file name for each of the one or more resources. In some embodiments, the method can include identifying, by the resource receiver, the one or more objects encrypted by a hash. In some embodiments, the method can include identifying, by the resource receiver, the starting metadata file encrypted by a hash. In some embodiments, the method can include determining, by the resource receiver, the directory hierarchy according to the ordered list of the one or more unique children identifiers.

In some embodiments, the method can include receiving, by the device from the second device, the one or more resources. In some embodiments, the method can include identifying, by the resource receiver, from the one or more metadata files, a file extension for each of the one or more resources. In some embodiments, the method can include adding, by the resource receiver, the file extension to each of the one or more resources received by the device.

In some embodiments, the method can include receiving, by the device, a second set of one or more metadata files. In some embodiments, the method can include identifying, by the resource receiver, from the second set of one or more metadata files, a second set of one or more sub-directories based on a second set of unique child identifiers of the second set of one or more metadata files. The second set of one or more sub-directories can order one or more resources stored in the sub-directory. In some embodiments, the method can include generating, by the resource receiver, a comparison between the second set of one or more sub-directories to the one or more sub-directories. In some embodiments, the method can include identifying, by the resource receiver from the comparison, a sub-directory present in the one or more sub-directories but not in the second set of one or more sub-directories. In some embodiments, the method can include removing, by the resource receiver from the device, each resource associated with the sub-directory.

In certain embodiments, the method can include generating, by the resource receiver, a user interface comprising the directory hierarchy. In certain embodiments, the method can include removing, by the resource receiver, the sub-directory and each resource associated with the sub-directory from the user interface.

In some embodiments, the method can include receiving, by the device, at a first time, a first metadata file of the one or more objects. In some embodiments, the method can include identifying, by the resource receiver, in the first metadata file, a first resource of the one or more resources and a first parent identifier. In some embodiments, the method can include receiving, by the device, at a second time subsequent to the first time, a second metadata file of the one or more metadata files. In some embodiments, the method can include identifying, by the resource receiver, that the second metadata file corresponds to the first parent identifier and identifies a first sub-directory comprising a first child identifier corresponding to the first resource. In some embodiments, the method can include storing, by the resource receiver, based on the first child identifier and the first parent identifier, the first resource file in the first sub-directory. In certain embodiments, the method can include displaying, by the resource receiver, in a user interface, the first resource file in the first sub-directory.

### BRIEF DESCRIPTION OF THE FIGURES

The foregoing and other objects, aspects, features, and advantages of the present solution will become more apparent and better understood by referring to the following description taken in conjunction with the accompanying drawings, in which:

FIG. 1A is a block diagram of embodiments of a computing device;

FIG. 1B is a block diagram depicting a computing environment comprising a client in communication with cloud service providers;

FIG. 2A is a block diagram of a system for optimized resource packaging in accordance with an illustrative embodiment;

FIG. 2B is an illustration of example metadata files for optimized resource packaging in accordance with an illustrative embodiment;

FIG. 3 is a graphical user interface for displaying a directory hierarchy in accordance with an illustrative embodiment; and

FIG. 4 is a flow diagram of a method for optimized resource packaging in accordance with an illustrative embodiment.

The features and advantages of the present solution will become more apparent from the detailed description set forth below when taken in conjunction with the drawings, in which like reference characters identify corresponding elements throughout. In the drawings, like reference numbers generally indicate identical, functionally similar, and/or structurally similar elements.

### DETAILED DESCRIPTION

For purposes of reading the description of the various embodiments below, the following descriptions of the sections of the specification and their respective contents may be helpful:

Section A describes a computing environment which may be useful for practicing embodiments described herein; and

Section B describes systems and methods for optimized resource packaging for resource-bound delivery and consumer devices.

### A. Computing Environment

Prior to discussing the specifics of embodiments of the systems and methods of an appliance and/or client, it may be helpful to discuss the computing environments in which such embodiments may be deployed.

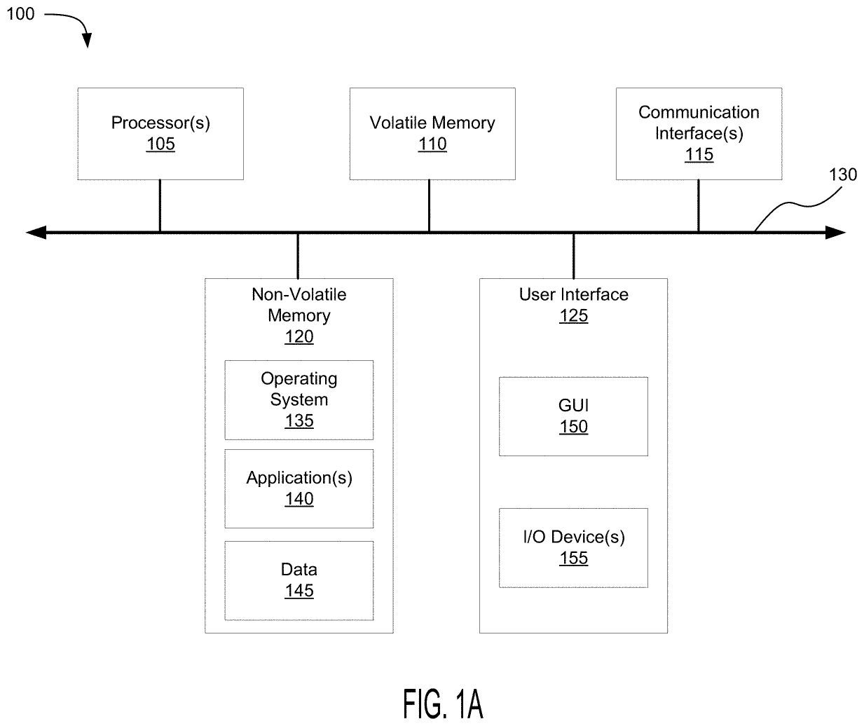

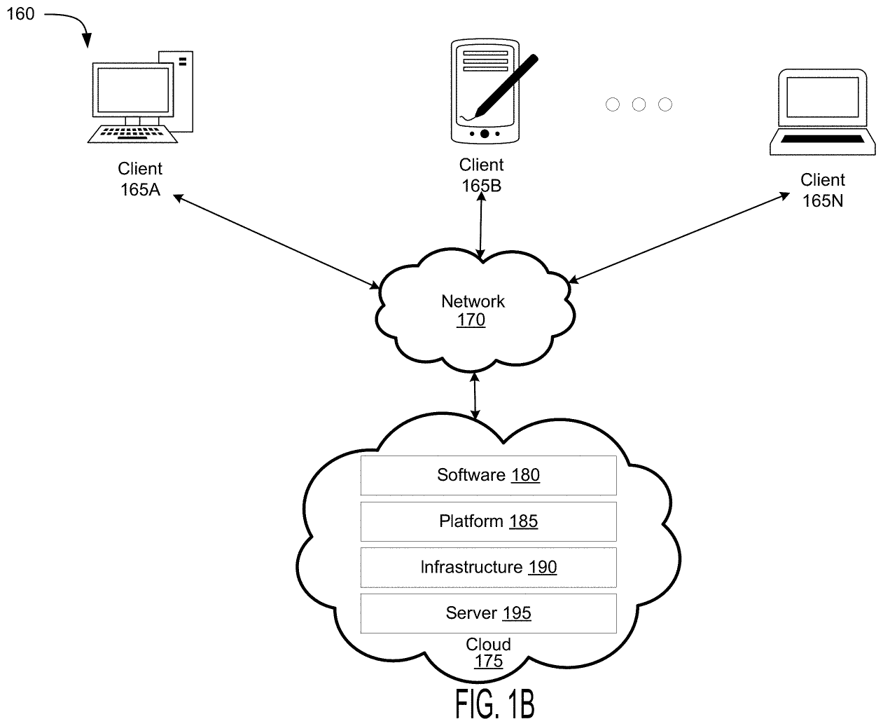

As shown in FIG. 1A, computer 100 may include one or more processors 105, volatile memory 110 (e.g., random access memory (RAM)), non-volatile memory 120 (e.g., one or more hard disk drives (HDDs) or other magnetic or optical storage media, one or more solid state drives (SSDs) such as a flash drive or other solid state storage media, one or more hybrid magnetic and solid state drives, and/or one or more virtual storage volumes, such as a cloud storage, or a combination of such physical storage volumes and virtual storage volumes or arrays thereof), user interface (UI) 125, one or more communications interfaces 115, and communication bus 130. User interface 125 may include graphical user interface (GUI) 150 (e.g., a touchscreen, a display, etc.) and one or more input/output (I/O) devices 155 (e.g., a mouse, a keyboard, a microphone, one or more speakers, one or more cameras, one or more biometric scanners, one or more environmental sensors, one or more accelerometers, etc.). Non-volatile memory 120 stores operating system 135, one or more applications 140, and data 145 such that, for example, computer instructions of operating system 135 and/or applications 140 are executed by processor(s) 105 out of volatile memory 110. In some embodiments, volatile memory 110 may include one or more types of RAM and/or a cache memory that may offer a faster response time than a main memory. Data may be entered using an input device of GUI 150 or received from I/O device(s) 155. Various elements of computer 100 may communicate via one or more communication buses, shown as communication bus 130.

Computer 100 as shown in FIG. 1A is shown merely as an example, as clients, servers, intermediary and other networking devices and may be implemented by any computing or processing environment and with any type of machine or set of machines that may have suitable hardware and/or software capable of operating as described herein. Processor(s) 105 may be implemented by one or more programmable processors to execute one or more executable instructions, such as a computer program, to perform the functions of the system. As used herein, the term “processor” describes circuitry that performs a function, an operation, or a sequence of operations. The function, operation, or sequence of operations may be hard coded into the circuitry or soft coded by way of instructions held in a memory device and executed by the circuitry. A “processor” may perform the function, operation, or sequence of operations using digital values and/or using analog signals. In some embodiments, the “processor” can be embodied in one or more application specific integrated circuits (ASICs), microprocessors, digital signal processors (DSPs), graphics processing units (GPUs), microcontrollers, field programmable gate arrays (FPGAs), programmable logic arrays (PLAs), multi-core processors, or general-purpose computers with associated memory. The “processor” may be analog, digital or mixed-signal. In some embodiments, the “processor” may be one or more physical processors or one or more “virtual” (e.g., remotely located or “cloud”) processors. A processor including multiple processor cores and/or multiple processors multiple processors may provide functionality for parallel, simultaneous execution of instructions or for parallel, simultaneous execution of one instruction on more than one piece of data.

Communications interfaces 115 may include one or more interfaces to enable computer 100 to access a computer network such as a Local Area Network (LAN), a Wide Area Network (WAN), a Personal Area Network (PAN), or the Internet through a variety of wired and/or wireless or cellular connections.

In described embodiments, the computing device 100 may execute an application on behalf of a user of a client computing device. For example, the computing device 100 may execute a virtual machine, which provides an execution session within which applications execute on behalf of a user or a client computing device, such as a hosted desktop session. The computing device 100 may also execute a terminal services session to provide a hosted desktop environment. The computing device 100 may provide access to a computing environment including one or more of: one or more applications, one or more desktop applications, and one or more desktop sessions in which one or more applications may execute.

Referring to FIG. 1B, a computing environment 160 is depicted. Computing environment 160 may generally be considered implemented as a cloud computing environment, an on-premises (“on-prem”) computing environment, or a hybrid computing environment including one or more on-prem computing environments and one or more cloud computing environments. When implemented as a cloud computing environment, also referred as a cloud environment, cloud computing, or cloud network, computing environment 160 can provide the delivery of shared services (e.g., computer services) and shared resources (e.g., computer resources) to multiple users. For example, the computing environment 160 can include an environment or system for providing or delivering access to a plurality of shared services and resources to a plurality of users through the internet. The shared resources and services can include, but are not limited to, networks, network bandwidth, servers, processing, memory, storage, applications, virtual machines, databases, software, hardware, analytics, and intelligence.

In embodiments, the computing environment 160 may provide client 165 with one or more resources provided by a network environment. The computing environment 160 may include one or more clients 165A-165N, in communication with a cloud 175 over one or more networks 170. Clients 165 may include, e.g., thick clients, thin clients, and zero clients. The cloud 175 may include back end platforms, e.g., servers, storage, server farms or data centers. The clients 165 can be the same as or substantially similar to computer 100 of FIG. 1A.

The users or clients 165 can correspond to a single organization or multiple organizations. For example, the computing environment 160 can include a private cloud serving a single organization (e.g., enterprise cloud). The computing environment 160 can include a community cloud or public cloud serving multiple organizations. In embodiments, the computing environment 160 can include a hybrid cloud that is a combination of a public cloud and a private cloud. For example, the cloud 175 may be public, private, or hybrid. Public clouds 175 may include public servers that are maintained by third parties to the clients 165 or the owners of the clients 165. The servers may be located off-site in remote geographical locations as disclosed above or otherwise. Public clouds 175 may be connected to the servers over a public network 170. Private clouds 175 may include private servers that are physically maintained by clients 165 or owners of clients 165. Private clouds 175 may be connected to the servers over a private network 170. Hybrid clouds 175 may include both the private and public networks 170 and servers.

The cloud 175 may include back-end platforms, e.g., servers, storage, server farms or data centers. For example, the cloud 175 can include or correspond to a server or system remote from one or more clients 165 to provide third-party control over a pool of shared services and resources. The computing environment 160 can provide resource pooling to serve multiple users via clients 165 through a multi-tenant environment or multi-tenant model with different physical and virtual resources dynamically assigned and reassigned responsive to different demands within the respective environment. The multi-tenant environment can include a system or architecture that can provide a single instance of software, an application or a software application to serve multiple users. In embodiments, the computing environment 160 can provide on-demand self-service to unilaterally provision computing capabilities (e.g., server time, network storage) across a network for multiple clients 165. The computing environment 160 can provide an elasticity to dynamically scale out or scale in responsive to different demands from one or more clients 165. In some embodiments, the computing environment 160 can include or provide monitoring services to monitor, control and/or generate reports corresponding to the provided shared services and resources.

In some embodiments, the computing environment 160 can include and provide different types of cloud computing services. For example, the computing environment 160 can include Infrastructure as a Service (IaaS). The computing environment 160 can include Platform as a Service (PaaS). The computing environment 160 can include server-less computing. The computing environment 160 can include Software as a Service (SaaS). For example, the cloud 175 may also include a cloud based delivery, e.g., Software as a Service (SaaS) 180, Platform as a Service (PaaS) 185, and Infrastructure as a Service (IaaS) 190. IaaS may refer to a user renting the use of infrastructure resources that are needed during a specified time period. IaaS providers may offer storage, networking, servers or virtualization resources from large pools, allowing the users to quickly scale up by accessing more resources as needed. Examples of IaaS include AMAZON WEB SERVICES provided by Amazon.com, Inc., of Seattle, Wash.; RACKSPACE CLOUD provided by Rackspace US, Inc., of San Antonio, Tex.; Google Compute Engine provided by Google Inc. of Mountain View, Calif.; or RIGHTSCALE provided by RightScale, Inc., of Santa Barbara, Calif. PaaS providers may offer functionality provided by IaaS, including, e.g., storage, networking, servers, or virtualization, as well as additional resources such as, e.g., the operating system, middleware, or runtime resources. Examples of PaaS include WINDOWS AZURE provided by Microsoft Corporation of Redmond, Wash.; Google App Engine provided by Google Inc.; and HEROKU provided by Heroku, Inc., of San Francisco, Calif. SaaS providers may offer the resources that PaaS provides, including storage, networking, servers, virtualization, operating system, middleware, or runtime resources. In some embodiments, SaaS providers may offer additional resources including, e.g., data and application resources. Examples of SaaS include GOOGLE APPS provided by Google Inc.; SALESFORCE provided by Salesforce.com Inc. of San Francisco, Calif.; or OFFICE 365 provided by Microsoft Corporation. Examples of SaaS may also include data storage providers, e.g., DROPBOX provided by Dropbox, Inc. of San Francisco, Calif.; Microsoft SKYDRIVE provided by Microsoft Corporation; Google Drive provided by Google Inc.; or Apple ICLOUD provided by Apple Inc. of Cupertino, Calif.

Clients 165 may access IaaS resources with one or more IaaS standards, including, e.g., Amazon Elastic Compute Cloud (EC2), Open Cloud Computing Interface (OCCI), Cloud Infrastructure Management Interface (CIMI), or OpenStack standards. Some IaaS standards may allow clients access to resources over HTTP, and may use Representational State Transfer (REST) protocol or Simple Object Access Protocol (SOAP). Clients 165 may access PaaS resources with different PaaS interfaces. Some PaaS interfaces use HTTP packages, standard Java APIs, JavaMail API, Java Data Objects (JDO), Java Persistence API (JPA), Python APIs, web integration APIs for different programming languages including, e.g., Rack for Ruby, WSGI for Python, or PSGI for Perl, or other APIs that may be built on REST, HTTP, XML, or other protocols. Clients 165 may access SaaS resources through the use of web-based user interfaces, provided by a web browser (e.g., GOOGLE CHROME, Microsoft INTERNET EXPLORER, or Mozilla Firefox provided by Mozilla Foundation of Mountain View, Calif.). Clients 165 may also access SaaS resources through smartphone or tablet applications, including, e.g., Salesforce Sales Cloud, or Google Drive app. Clients 165 may also access SaaS resources through the client operating system, including, e.g., Windows file system for DROPBOX.

In some embodiments, access to IaaS, PaaS, or SaaS resources may be authenticated. For example, a server or authentication server may authenticate a user via security certificates, HTTPS, or API keys. API keys may include various encryption standards such as, e.g., Advanced Encryption Standard (AES). Data resources may be sent over Transport Layer Security (TLS) or Secure Sockets Layer (SSL).

### B. Systems and Methods for Optimized Resource Packaging for Resource-Bound Delivery and Consumer Devices

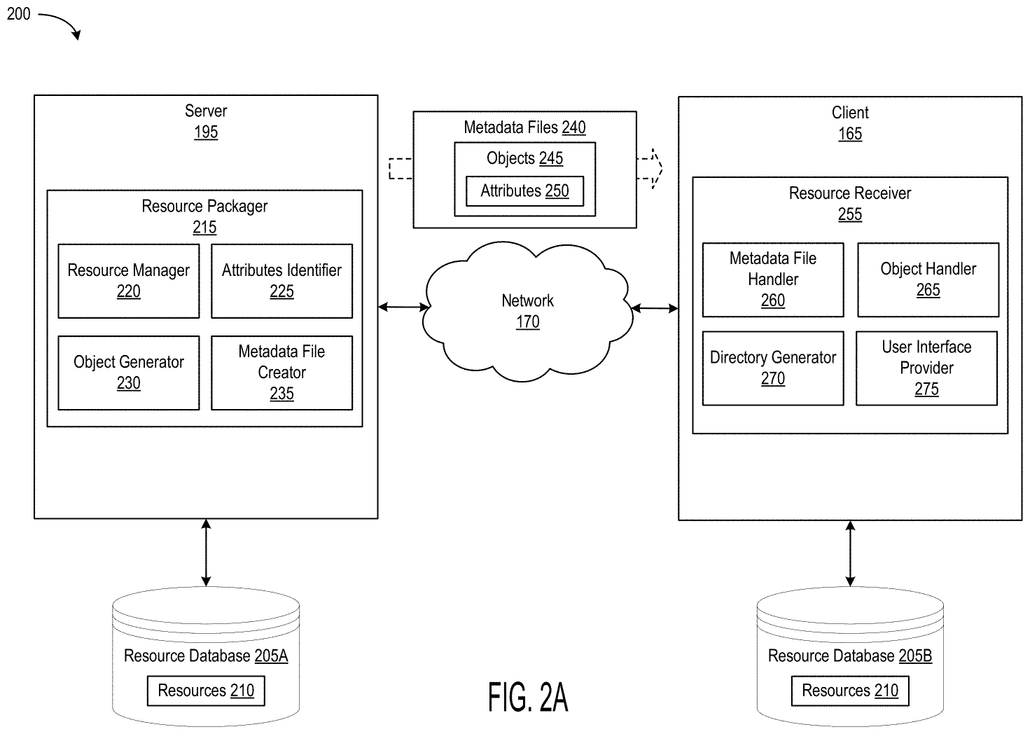

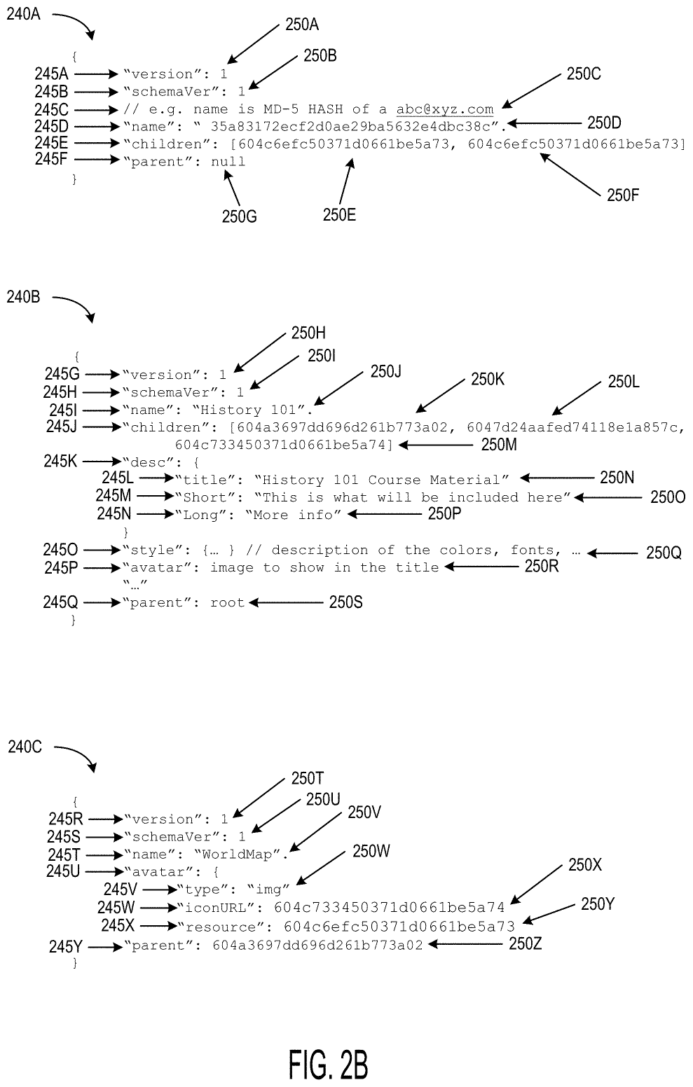

Referring now to FIG. 2A, depicted is a block diagram of a system 200 for optimized resource packaging for resource-bound delivery and consumer devices. In brief overview, the system 200 may include a client 165, a network 170, a server 195, and one or more resource databases 205A and 205B (generally referred to as resource database 205). The client 165 can be communicatively coupled to the resource database 205B, and the server 195 can be communicatively coupled to the resource database 205A. The client 165 and the server 195 can be communicatively coupled via the network 170. The server 195 can include a resource packager 215. The resource packager 215 can include a resource manager 220, an attributes identifier 225, an object generator 230, and a metadata file creator 235. The server 195 can transmit metadata files 240 via the network 170. The client 165 can receive the metadata files 240 via the network 170. The client 165 can include a resource receiver 255. The resource receiver 255 can include a metadata file handler 260, an object handler 265, and a directory generator 270, and a user interface (UI) provider 275.

The resource packager 215 and the resource receiver 255 (including the resource manager 220, the attributes identifier 225, the object generator 230, the metadata file creator 235, the metadata file handler 260, the object handler 265, the directory generator 270, and the UI provider 275) may be implemented using components described in connection with FIGS. 1A and 1B. Each of the above-mentioned elements or entities can be implemented in hardware, or a combination of hardware and software, in one or more embodiments. Each component of the system 200 may be implemented using hardware or a combination of hardware or software detailed above in connection with FIGS. 1A and 1B. Each of these elements or entities can include any application, program, library, script, task, service, process, or any type and form of executable instructions executing on hardware of the resource manager 220, the attributes identifier 225, the object generator 230, the metadata file creator 235, the metadata file handler 260, the object handler 265, the directory generator 270, and the UI provider 275. The hardware includes circuitry such as one or more processors in one or more embodiments.

The resource database 205 can manage how and where data is stored. The resource database 205 can be any type and form of database or data storage to store resources 210 such as directories, sub-directories, files, programs, functions, applications, or any other electronic record. The resource database 205 can also store metadata describing the resources 210. The resource database 205 can also store images, icons, or logos relating to the resources 210. The resource database 205 can also include the directory hierarchy that organizes the resource database 205.

The resource packager 215 can allow the server 195 to share the directory hierarchy with the client 165. The resource packager 215 can analyze or identify the resources to 210 in the directory hierarchy. The resource packager 215 can package or generate attributes 250 of the resources 210 into objects 245 to include in metadata files 240 associated with the resources. The resource packager 215 can prepare the metadata files 240 for transmission to the client 165. The resource packager 215 can also share the metadata files 240 with the metadata file creator 235 to secure the metadata files 240.

The resource manager 220 can manage, retrieve, or access resources 210 stored in or by the resource database 205A. The resource manager 220 can communicate with the resource database 205 via an Application Programming Interface (API). The resource manager 220 can identify the directory hierarchy of the resources 210 stored by the resource database 205A. The resource manager 220 can receive the directory hierarchy describing the resources for a user or network administrator of the resource database 205A. The resource manager 220 can also configure the resource database 205A to provide the directory hierarchy describing the resources stored therein. The resource manager 220 can identify each resource 210 within the directory hierarchy or stored in or by the resource database 205A. The resource manager 220 can retrieve metadata associated with the resources 210. For example, the resource manager 220 can retrieve metadata that describes the size or title of the resources 210. The resource manager 220 can also relate information relating to the resource 210, such as an icon or image for the resource 210.

The attributes identifier 225 can identify, determine, or access attributes 250 of the resources 210. The attributes identifier 225 can identify attributes 250 corresponding to directory hierarchy information such as folder structure, physical resource file, or metadata describing the directory hierarchy of resources 210. For example, the attributes identifier 225 can identify attributes 250 indicating that a resource 210 belongs to a particular sub-directory within the directory hierarchy. The attributes identifier 225 can also identify attributes 250 that include alphanumeric directory names, color-coding of folders, font, tags, versioning, file extension, and other information relating to the resources 210 and the directory hierarchy. Similarly, the attributes identifier 225 can identify attributes 250 relating to a version of a resource 210, a name of the resource 210, parents and children of the resource 210, descriptions of the resource 210, style of the resource 210, and an avatar of the resource 210.

The attributes identifier 225 can identify attributes 250 relating to the version of the resource 210. For example, the attributes identifier 225 can identify that the resource 210 is a first version or a second version. The attributes identifier 225 can identify a name of the resource 210. For example, the attributes identifier 225 can identify that the name of the resource 210 is “Program.” Similarly, the attributes identifier 225 can identify attributes relating to file extensions of the resource 210, such as “.exe” for the resource 210 “Program.exe.”

The attributes identifier 225 can identify parent-child relationships of the resource 210. The parent-child relationship establishes hierarchal dependencies between resources. A parent, which can be identified by a parent identifier, can be a resource such as a root directory, directory, or program that references children by their child identifiers. The children, which can be identified by the child identifiers, can be the resources, such as the sub-directories or other programs, referenced by the parent. The children can reference their parent via the parent identifier of the parent. A child can also be a parent for sub-directories or resources of the child. The attributes identifier 225 can identify the children identifiers corresponding to the children and the parent identifiers corresponding to the parents. The identifiers can be a hash or a key. The unique identifiers can correspond to a path to the resource, such as a file system path or a web address. For example, the attributes identifier 225 can identify that the “Program” is a child stored in a parent root directory “Main,” and that the “Program” folder is a parent of a child file “Program.exe” stored in the “Program” folder. By identifying the parent-child relationships of the resources, the attributes identifier 225 can flatten the directory hierarchy while maintaining the relationships between directories, sub-directories, and the resources 210 therein.

The attributes identifier 225 can identify attributes 250 relating to descriptions that include a title of the resource 210. For example, the title can indicate that the title of the resource 210 is “History 101 Course Material.” The attributes identifier 225 can identify a short description of the resource 210. For example, the short description can include a text string that includes “this course is about American history.” The attributes identifier 225 can also identify a long description of the resource 210. For example, the long description can include a text string that includes “this course is about American politics during the 20^{th} century and will include a research assignment.”

The attributes identifier 225 can identify attributes 250 relating to a style for the resource 210. The attributes identifier 225 can identify colors, fonts, and sizes of the resource 210. For example, the style can specify that the name of resource 210 include a blue color in a large font in the directory hierarchy presented by the UI provider 275.

The attributes identifier 225 can identify attributes 250 relating to an avatar of the resource 210. The avatar can specify a logo or image of the resource 210 to display in the directory hierarchy along with the title of the resource 210. The attributes identifier 225 can identify whether the avatar specifies a type, iconURL, or a resource 210. The type can specify a file type of the avatar, such as “img” or “jpg.” The iconURL can specify an address or directory from where to retrieve the avatar, such as a database or network location. The resource 210 can specify the exact file that corresponds to the avatar, such as “image.jpg.”

The object generator 230 can generate or create objects 245 from the attributes 250. The object generator 230 can generate objects 245 that have identifiers that represent the attributes 250 of the resources 210. The object generator 230 can also generate attributes 250 that specify the inter-relationships between the objects 245, the order of the resources 210 relative to one another, additional presentation layer information, and security protocols for the objects 245 or the resources 210.

The object generator 230 can organize the objects 245 by a unique identifier. The object generator 230 can organize the objects 245 independently of any naming protocols or naming convention for the directory hierarchy. The object generator 230 can also generate objects 245 that are independent of the resources 210 that they represent. For example, the object generator 230 can organize objects 245 regardless of whether the resource manager 220 hides the corresponding resources 210 in the resource database 205A. For example, the object generator 230 can generate objects 245 corresponding to information relating to a 360-view map or photo file, which may include both visible and hidden resources 210. The objects 245 can be associated with the metadata files 240.

The metadata file creator 235 can create or generate metadata files 240 from the objects. The metadata file creator 235 can create a starting metadata file 240. The starting metadata file 240 can include a set of objects 245 describing a starting file or relationships to other metadata files 240. For example, the starting metadata file 240 can include objects 245 corresponding to a user login and credentials, and an ordered list of additional objects 245 that are applicable to the user login and credential. The ordered list of objects can correspond to resources 210 such that the ordered list provides an ordering the resources 210 in the directory hierarchy.

Referring now to FIG. 2B in conjunction with FIG. 2A, depicted is embodiment of a starting metadata file 240A describing a starting resource 210A. The starting metadata file 240A can include an object 245A, “version,” with an attribute 250A indicating a version “1” of the resource 210A. The starting metadata file 240 can include an object 245B, “schemaVer,” with an attribute 250B indicating a schema version “1” of the resource 210A. The starting metadata file 240A can include an object 245C, the comment “II” with an attribute 250C indicating that the object 245D, “name,” is hashed user login information, “name is MD-5 HASH of a abc@xyz.com.” The hashed user login information is attribute 250D, “35a83172ecf2d0ae29ba5632e4dbc38c.” The starting metadata file 240A can include object 245E, “children,” with attributes 250E “604c6efc50371d0661be5a73” and 250F “604c6efc50371d0661be5a73” indicating the hashed children identifiers of the resource 210A. The starting metadata file 240A can also include object 245F, “parent,” with an attribute 250G indicating a parent of “null” of the resource 210A because the starting metadata file 240A is the parent or root of all the other metadata files 240.

The starting metadata file 240 may also correspond to root directories that remain constant over time. Since the metadata file creator 235 creates the starting metadata file without describing the entire hierarchy structure in one file, the directory hierarchy can change without affecting the root directory described by the starting metadata file. The metadata file creator 235 can indicate that the parent is null for the starting metadata file 240.

The metadata file creator 235 can create additional metadata files 240 corresponding to additional directories and files added to a file system or directory hierarchy. For example, an educational hierarchy can include a student taking a set of classes, where over the course of the school year, the changes in the classes are infrequent and hence the corresponding files do not have to change over time. However, the lessons and materials of each class may change over time. The metadata file creator 235 can create the additional metadata files to correspond to directories, sub-directories, files, resources, and documents. The metadata file creator 235 can create the additional metadata files to allow for a recursive directory hierarchy. For example, the metadata file creator 235 can create the additional metadata files 240 to correspond to the child identified in the starting metadata file 240. The metadata file creator 235 can create an ordering of the identified children within each metadata file to indicate the ordering of the folders or documents within a folder. The metadata file creator 235 can create the additional metadata file 240 to reference the starting metadata file 240 as a parent.

For example, an additional metadata file 240B describes a resource 210B. The metadata file 240B can include an object 245G, “version,” with an attribute 250H indicating a version “1” of the resource 210B. The metadata file 240B can include an object 245H, “schemaVer,” with an attribute 250I indicating a schema version “1” of the resource 210B. The metadata file 240B can include an object 245I, “name,” with an attribute 250J indicating that the name of the resource 210B is “History 101.” The metadata file 240B can include object 245J, “children,” with attributes 250K “604a3697dd696d261b773a02,” 250L “6047d24aafed74118e1a857c,” and 250M “604c733450371da0661be5a74” indicating the children identifiers of the resources 210 of the resource 210B. The ordering of attributes 250K 250L, and 250M indicates that the resources 210 corresponding to those attributes 250 are in that specific order. The metadata file 240B can also include object 245K, “desc,” with one or more objects 245L-N describing the resource 210B. For example, the object 245L, “title,” includes attribute 250N of “History 101 Course Material.” The object 245M, “short,” includes attribute 250O of “This is what will be included here.” The object 245N, “Long,” includes attribute 250P of “More info.” The metadata file 240B can include object 245O, “style,” with attribute 250Q indicating “description of the colors, fonts” and other stylistic parameters of the resource 210B. The metadata file 240B can similarly include object 245P, “avatar,” with attribute 250R indicating an “image to show in the title” of the resource 210B. The metadata file 240B can also include object 245Q, “parent,” with an attribute 250S indicating that a parent of the resource 210B is “root.” The “root” can correspond to the resource 210A described by the starting metadata file 240A.

The metadata file creator 235 can also create a metadata file 240 for a document by including metadata corresponding to the name, type, and resource associated with the document. For example, metadata file 240C describes a resource 210C that is a document. The metadata file 240C can include an object 245R, “version,” with an attribute 250T indicating a version “1” of the resource 210C. The metadata file 240C can include an object 245S, “schemaVer,” with an attribute 250U indicating a schema version “1” of the resource 210C. The metadata file 240C can include an object 245T, “name,” with an attribute 250V indicating that the name of the resource 210C is “WorldMap.” The metadata file 240C can include object 245U, “avatar,” with one or more objects 245 describing the “avatar.” For example, object 245V, “type,” with attribute 250W “img” indicates a file type of the “avatar” for the resource 210C. Object 245W, “iconURL,” with attribute 250X “604c6efc50371d0661be5a73” indicates a hashed file path to the file for the “avatar” for the resource 210C. Object 245X, “resource,” with attribute 250Y “604c6efc50371d0661be5a73” indicates a resource 210D of the file for the “avatar” for the resource 210C. The metadata file 240C can also include object 245Y, “parent,” with an attribute 250Z indicating that a parent of the resource 210C is “604a3697dd696d261b773a02.” The attribute 250Z can correspond to the resource 210B described by the metadata file 240B.

The metadata file creator 235 can encrypt or secure the metadata files 240. The metadata file creator 235 can obfuscate the attributes 250 or information referenced by the objects 245. The metadata file creator 235 can encrypt or sign the metadata files 240 to avoid tampering. For example, the metadata file creator 235 can obfuscate attributes 250 stored by the objects 245 by creating a hash and by using other security measures. For example, the children, parent, iconURL, or resource identifiers can be a hash such as “604a3697dd696d261b773a02.” The metadata file creator 235 can also create or generate unique identifiers for each metadata files 240. For example, the metadata files 240 can have a hash such as “604c6efc50371d0661be5a73.” By obfuscating the metadata files 240, the metadata file creator 235 thus secures the directory hierarchy from unauthorized third parties. Additionally, the metadata file creator 235 can remove attributes 250 from the resources 210 if the objects 245 of the metadata files 240 securely store the information. For example, the objects 245 can include attributes 250 corresponding to a file extension of a resource 210, so the metadata file creator 235 can remove the file extension from the resources 210 transmitted to the client 165. Therefore, the metadata file creator 235 prevents the unauthorized entities from inspecting and detecting the file formats of the resources 210.

The server 195 can transmit, transfer, or communicate metadata files 240 via the network 170. The network can include the over the air (OTA) transmissions such as advanced television systems committee standards (ATSC). ATSC can include ATSC 1.0, which can correspond to the first digital television standard. ATSC 1.0 can support high definition television, multicast, surround sound, a bit rate of up to 19.4 Mbps, coverage with 15 dB, and 8VSB modulation. ATSC can also include ATSC 3.0, which can include a more efficient spectrum supporting flexible bit rates and various coverage areas, multiple simultaneous bit pipes, UHD and/or HD multicast, OFDM techniques for bit rates between 28 to 36 Mbps over a 6 MHz bandwidth, and a video resolution of 3840×2160 up to 60 frames per second (4K UHD TV).

The server 195 can share, transfer, or transmit the metadata files 240 created by the metadata file creator 235. For example, as previously described herein, the metadata file creator 235 can create the starting metadata file 240 to describe a starting file or root directory to establish relationships with other metadata files 240. The metadata file creator 235 can also create additional metadata files 240 corresponding to additional directories and files added to a file system or directory hierarchy. The server 195 can transmit the starting metadata file 240 and the additional metadata files 240 to another system or appliance. The server 195 can transmit the metadata files 240 at different times. The server 195 can transmit the metadata files 240 in a variety of orders or batches. For example, the server 195 can first transmit one or more metadata files 240 and then afterwards transmit a starting metadata file 240. The resource packager 215 can also create the metadata files 240 to have a small data size such that multiple metadata files 240 can fit in a transmission chunk of metadata files 240 transmitted to another system.

Similarly, the server 195 can transmit metadata files 240 corresponding to a first sub-directory and then additional metadata files 240 corresponding to a second sub-directory. For example, the server 195 can transmit 7 hashed metadata files to the client 165 in the following order: 604c6efc50371d0661be5a73, 604c733450371d0661be5a74, 604a1acf691c040f17f52f1b, 604a3697dd696d261b773a02, 604c733450371d0661be5a74, 6047d242afed74118e1a857a, and 6047d24aafed74118e1a857c. However, the third and sixth metadata files, 604a3697dd696d261b773a02 and 6047d242afed74118e1a857a, may correspond to resources 210 in the second sub-directory while the other metadata files correspond to resources in the first sub-directory. However, the client 165 can determine from the metadata files 240 which resources belong to which sub-directory.

The client 165 can receive the metadata files 240 via the network 170. The client 165 can include the resource database 205B and the resource receiver 255, which can include the metadata file handler 260, the object handler 265, the directory generator 270, and the UI provider 275.

The server 195 and the client 165 can share the directory hierarchies via metadata files 240 across a dedicated protocol layer. For example, the server 195 and the client 165 can mix protocol layers, wherein each layer can serve a different purpose. As such, the server 195 can share the directory hierarchy with the client 165 without having to change the underlying delivery protocols. For example, the server 195 does not need to adjust a connection to the client 165 when there are any physical delivery changes between mechanisms such as cable delivery, ATSC 3.0 broadcast delivery, ATSC 1.0 datacasting, and Broadband (Internet). Therefore, the server 195 and the client 165 can use one protocol layer to share the directory hierarchy while transmitting the resources across a second protocol layer. For example, one layer may be for the delivery of resources, and the metadata files may establish a hierarchy or relationship between these resources. Additionally, by separating the delivery of the hierarchy and the resources, the server 195 and the client 165 can interface with any resource database 205 while maintaining the directory hierarchy structure for an application service provided by the server 195 to the client 165.

The resource receiver 255 can receive or analyze the metadata files 240. The resource receiver 255 can receive the metadata files 240 transmitted by the server 195 via the network 170. The resource receiver 255 can also analyze the metadata files 240 that are encrypted or hashed. The resource receiver 255 can receive the metadata files out of order. For example, the receiving system can first receive metadata files 240 corresponding to resources and then receive a starting metadata file corresponding to a directory for those resources. The resource receiver 255 can recreate the directory hierarchy of resources 210 based on the objects 245 with attributes 250 in the metadata files 240. The resource receiver 255 can use the attributes 250 to reconstruct the directory hierarchy that includes the directory identified by the starting metadata file 240 referencing the resources identified by the metadata files 240.

The metadata file handler 260 can receive, handle, or modify the metadata files 240. The metadata file handler 260 can decrypt, authenticate, or validate the metadata files 240. The metadata file handler 260 can convert encrypted metadata files 240 to decrypted metadata files 240 for analysis by the resource receiver 255. For example, the metadata file handler 260 can use a decryption key to convert the objects 245 and their attributes 250 in the metadata files 240 to a text format.

The metadata file handler 260 can identify objects 245 in the metadata files 240. The metadata file handler 260 can identify or track the versions of the metadata files 240 as they change over time based on schema versioning. The metadata file handler 260 can determine from the version whether the content of the metadata file 240 has changed and hence whether information needs to be reloaded for the directory hierarchy. The metadata file handler 260 can use schema versioning to determine how whether the resources 210 and their contents that are associated with the metadata files 240 change over time. The metadata file handler 260 can thus manage resources 210 that are subject to change.

The object handler 265 can handle, receive, or modify the objects 245. The object handler 265 can identify the attributes 250 in the objects 245. The object handler 265 can use the objects 245 with the attributes to identify information of the resources 210 associated with the metadata files 240. For example, the object handler 265 can identify from the objects 245 with attributes 250 whether the name of a directory or resource 210 changed. Moreover, since the name of a directory is an attribute 250 of the object 245, the object handler 265 can identify the modification or name change without affecting the directory hierarchy nor necessitating re-delivery of resources 210. The object handler 265 can also identify other attributes 250 of the resources 210 described by the objects 245 in the metadata data files 240. For example, the object handler 265 can identify the description, avatar, style, logo, or their parent/child identifiers.

The directory generator 270 can generate, create, or identify the directory hierarchy of the resources. The directory generator 270 can recreate the directory hierarchy for the resource database 205B such that it matches the directory hierarchy in the resource database 205A. The directory generator 270 can use the attributes 250 to create the directory hierarchy. For example, the directory generator 270 can use an attribute 250 corresponding to a directory title to create a directory with that name. Since the server 195 can changed, modify, or update the attributes 250, the directory generator 270 can identify updates the attributes 250. For example, the directory generator 270 can update the name of a directory based on an update to the corresponding attribute 250. Similarly, the directory generator 270 can recreate or update the directory hierarchy based on updates to attributes 250 relating to parent and child identifiers or the user credentials. The directory generator 270 creates each section of the directory hierarchy from corresponding metadata files 240. Therefore, if a metadata file 240 is lost or corrupted, the directory generator 270 can alter the directory hierarchy corresponding to the children of the missing metadata file 240 rather than the entire directory hierarchy. Moreover, the directory generator 270 can use the attributes 250 to update, modify, or delete resources 210. For example, after the directory generator 270 generates a new directory hierarchy based on updated attributes 250, if a resource 210 that previously was present is missing from the new directory hierarchy, then the directory generator 270 can request that the resource database 205B delete the missing resource 210.

The UI provider 275 can display, illustrate, or present the resources 210 according to the directory hierarchy. The UI provider 275 can display folders trees and resources 210 in their proper order based on the directory hierarchy generated by the directory generator 270. The UI provider 275 can generate a GUI for presentation of the directory hierarchy.

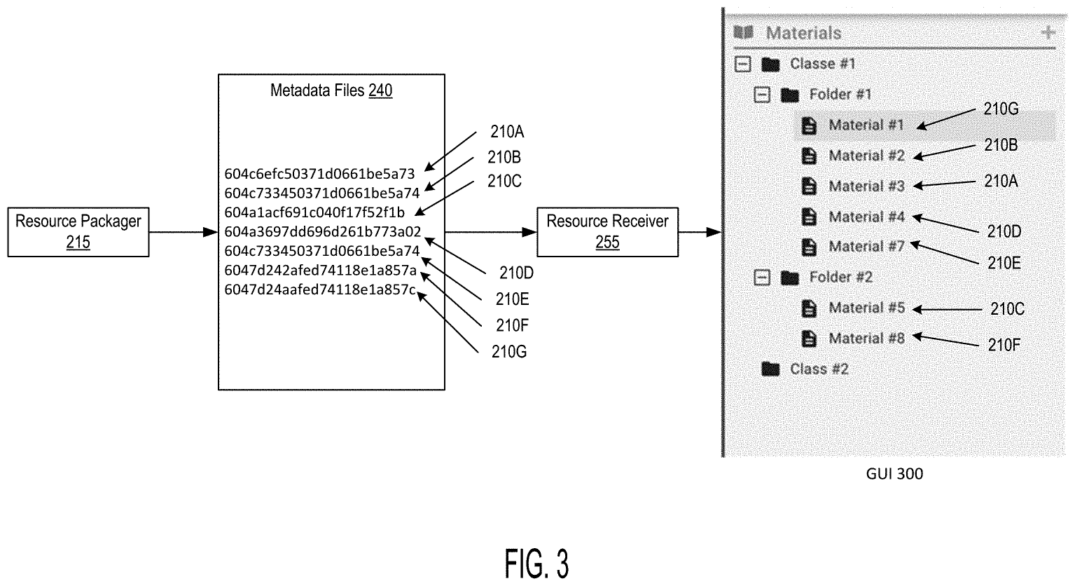

Now referring to FIG. 3 in conjunction with FIG. 2, depicted is an embodiment of a graphical user interface (GUI) 300 presented by the UI provider 275 to display the directory hierarchy based on the metadata files 240. The resource packager 215 can transmit the metadata files 240 that correspond to resources 210A-210G. The resource receiver 255 can receive the metadata files 240 and identify a directory hierarchy for the resources 210A-210G based on the metadata files 240. The UI provider 275 can then present the directory hierarchy of the resources 210A-210G based on their corresponding metadata files 240. Since the resource packager 215 can transmit the metadata files 240 out of order or the resource receiver 255 can receive the metadata files 240 out of order, the resource receiver 255 enables the UI provider 275 to display the resources 210 in their proper order in accordance to the identified directory hierarchy as presented in GUI 300.

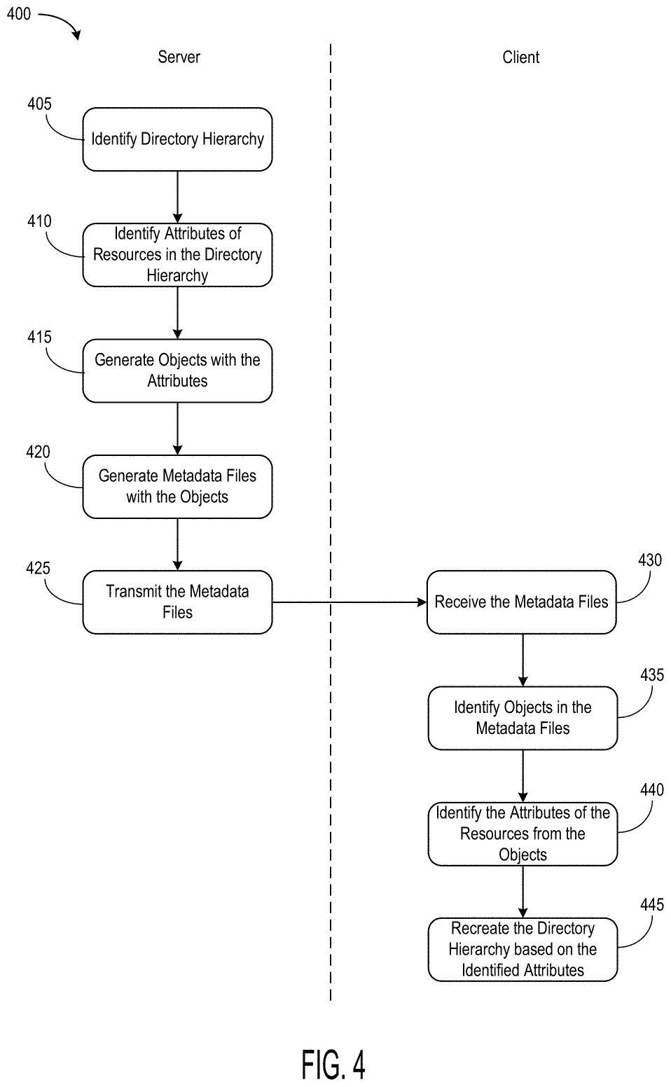

Referring now to FIG. 4, depicted is a flow diagram of an embodiment of a method 400 for optimized resource packaging for resource-bound delivery and consumer devices. The operations and functionalities of the method 400 may be performed by the components described in FIG. 1 and/or the system 200 detailed above. In brief overview, a server may identify a directory hierarchy (405). The server may identify attributes of the resources in the directory hierarchy (410). The server may generate objects with the attributes (415). The server may generate metadata files with the objects (420). The server may transmit the metadata files to a client (425). The client may receive the metadata files (430). The client may identify objects from the metadata files (435). The client may identify the attributes of the resources from the objects (440). The client may recreate the directory hierarchy based on the identified attributes (445).

The server (e.g., server 195) may identify a directory hierarchy (405). The server may identify the directory hierarchy from resources (e.g., resources 210) stored in a database (e.g., resource database 205). The server can identify a directory hierarchy of one or more sub-directories with one or more resources. The server can receive the directory hierarchy describing the resources for a user or network administrator of the resource database. The server can also configure the resource database to provide the directory hierarchy describing the resources stored therein.

The server may identify attributes (e.g., attributes 250) of the resources in the directory hierarchy (410). The server can identify attributes corresponding to hierarchy information such as folder structure, physical resource file, or metadata describing the directory hierarchy or its resources. For example, the server can identify attributes indicating that a resource belongs to a particular sub-directory within the directory hierarchy. The server can also identify attributes that include alphanumeric directory names, color-coding of folders, font, tags, versioning, file extension, and other information relating to the resources and the directory hierarchy. Similarly, the server can identify attributes relating to a version of a resource, a name of the resource, parents and children of the resource, descriptions of the resource, style of the resource, and an avatar of the resource.

The server may generate objects (e.g., objects 245) with the attributes (415). The server can encrypt, hash, or otherwise obfuscate the attributes in the objects to secure the information therein. The server can generate one or more objects to identify a file extension for each of the one or more resources. The server can remove the file extension from each of the one or more resources.

The server may generate metadata files (e.g., metadata files 240) with the objects (420). The server can generate, to describe the directory hierarchy, a starting metadata file describing user credential information and an ordered list of one or more unique children identifiers to identify one or more the metadata files for describing the one or more sub-directories. The server can one or more metadata files for each of the one or more sub-directories corresponding to at least the unique child identifiers of the starting metadata file. The server can generate the one or more metadata files to describe a name of the sub-directory, one or more resources stored in the sub-directory, and a parent identifier identifying the name of the starting metadata file. The server can generate the one or more metadata files to identify a second ordered list of one or more uniquely identified children directories to the sub-directory. The server can generate the at least one unique child identifier for each file name of the one or more resources. The server can encrypt the starting metadata file with a hash.

The server may transmit the metadata files to the client (e.g., client 165) (425). The server can communicate or transmit the directory hierarchy via a plurality of metadata files. The server can transmit the starting metadata file and the one or more metadata files to the client to cause the client to create the directory hierarchy using objects from the starting metadata file and the one or more metadata files. The server can transmit the one or more resources without the file extension.

The client may receive the metadata files (430). The client can receive the starting metadata file and the one or more metadata files. The client can receive a second set of one or more metadata files. The client can identify the starting metadata file encrypted by a hash. The client can receive the one or more resources. The client can identify, from the one or more metadata files, a file extension for each of the one or more resources. The client can receive one or more sets of the one more metadata files, such as a first set or a second set. The client can receive the first set at a first time and the second set at a second time. The client can receive the second set at the second time that is subsequent to the first. The client can receive a metadata file with one or more objects.

The client may identify objects from the metadata files (435). The client can identify, from the starting metadata file, user credential information and an ordered list of one or more unique children identifiers corresponding to each of the one or more metadata files describing one or more sub-directories. The client can identify, from the set of one or more metadata files, a set of one or more sub-directories based on a second set of unique child identifiers of the second set of one or more metadata files. The client can identify that the set of one or more sub-directories order the one or more resources stored in the set of one or more sub-directories. The client can identify the one or more objects encrypted by a hash.

The client may identify the attributes of the resources from the objects (440). The client can identify, from one or more objects of the one or more metadata files, a parent identifier identifying the starting metadata file. The client can also identify the one or more sub-directories. The client can identify child identifiers in the starting metadata file to determine an ordering one or more resources stored in the one or more sub-directories. The client can identify from the one or more objects of the one or more metadata files, an ordered list of one or more unique identifiers of children directories to the sub-directory. The client can identify, from the one or more objects of the one or more metadata files, a file name for each of the one or more resources. The client can identify, in the metadata files, a resource of the one or more resources and a parent identifier. The client can identify that one or more metadata files correspond to the parent identifier that identifies a first sub-directory comprising a child identifier corresponding to the first resource. The client can identify one or more sets of one or more sub-directories based on one or more unique child identifiers.

The client may recreate the directory hierarchy based on the identified attributes (445). The client can identify the directory hierarchy of the one or more sub-directories with the one or more resources. The client can generate the directory hierarchy using metadata from the starting metadata file and the one or more metadata files. The client can determine the directory hierarchy according to the ordered list of the one or more unique children identifiers. The client can add, the file extension identified by the objects in the metadata files, to each of the one or more resources received or stored by the client. The client can store, based on the child identifiers and the parent identifiers, the resource files in their appropriate sub-directory.

The client can generate a user interface to display the one or more sub-directories of the directory hierarchy. The client can display, in the user interface, the one or more resources stored in the sub-directory based on the ordered list. The client can display, in the user interface, one or more resources of the one or more sub-directories. For example, the client can display a first resource file in the first sub-directory in the second resource file in the second sub-directory. The client can generate a comparison between a second set of one or more sub-directories and a first or existing set of one or more sub-directories. The client can identify, from the comparison, a sub-directory present in the first set of the one or more sub-directories but not in the second set of one or more sub-directories. The client can remove from its database, each resource associated with the sub-directory that is present in the existing one or more sub-directories but not in the second set of the one or more sub-directories. The client can also remove the sub-directory and each of its resources from the user interface.

Various elements, which are described herein in the context of one or more embodiments, may be provided separately or in any suitable sub-combination. For example, the processes described herein may be implemented in hardware, software, or a combination thereof. Further, the processes described herein are not limited to the specific embodiments described. For example, the processes described herein are not limited to the specific processing order described herein and, rather, process blocks may be re-ordered, combined, removed, or performed in parallel or in serial, as necessary, to achieve the results set forth herein.

It should be understood that the systems described above may provide multiple ones of any or each of those components and these components may be provided on either a standalone machine or, in some embodiments, on multiple machines in a distributed system. The systems and methods described above may be implemented as a method, apparatus or article of manufacture using programming and/or engineering techniques to produce software, firmware, hardware, or any combination thereof. In addition, the systems and methods described above may be provided as one or more computer-readable programs embodied on or in one or more articles of manufacture. The term “article of manufacture” as used herein is intended to encompass code or logic accessible from and embedded in one or more computer-readable devices, firmware, programmable logic, memory devices (e.g., EEPROMs, ROMs, PROMs, RAMs, SRAMs, etc.), hardware (e.g., integrated circuit chip, Field Programmable Gate Array (FPGA), Application Specific Integrated Circuit (ASIC), etc.), electronic devices, a computer-readable non-volatile storage unit (e.g., CD-ROM, USB Flash memory, hard disk drive, etc.). The article of manufacture may be accessible from a file server providing access to the computer-readable programs via a network transmission line, wireless transmission media, signals propagating through space, radio waves, infrared signals, etc. The article of manufacture may be a flash memory card or a magnetic tape. The article of manufacture includes hardware logic as well as software or programmable code embedded in a computer-readable medium that is executed by a processor. In general, the computer-readable programs may be implemented in any programming language, such as LISP, PERL, C, C++, C#, PROLOG, or in any byte code language such as JAVA. The software programs may be stored on or in one or more articles of manufacture as object code.

While various embodiments of the methods and systems have been described, these embodiments are illustrative and in no way limit the scope of the described methods or systems. Those having skill in the relevant art can effect changes to form and details of the described methods and systems without departing from the broadest scope of the described methods and systems. Thus, the scope of the methods and systems described herein should not be limited by any of the illustrative embodiments and should be defined in accordance with the accompanying claims and their equivalents.

What is claimed is:

1. A method for communicating a file hierarchy using metadata, the method comprising
identifying, by a resource packager of a device, a directory hierarchy of one or more sub-directories with one or more resources;
generating, by the resource packager, for the directory hierarchy, a starting metadata file describing user credential information and an ordered list of one or more unique children identifiers to identify one or more the metadata files for describing the one or more sub-directories;
generating, by the resource packager, the one or more metadata files for each of the one or more sub-directories corresponding to at least the unique child identifiers of the starting metadata file, the one or more metadata files describing a name of the sub-directory, one or more resources stored in the sub-directory, and a parent identifier identifying the name of the starting metadata file; and
transmitting, by the device, the starting metadata file and the one or more metadata files to a second device to cause the second device to create the directory hierarchy using objects from the starting metadata file and the one or more metadata files.

2. The method of claim 1, further comprising generating, by the resource packager, the one or more metadata files to identify a second ordered list of one or more uniquely identified children directories to the sub-directory.

3. The method of claim 1, further comprising generating, by the resource packager, the at least one unique child identifier for each file name of the one or more resources.

4. The method of claim 1, further comprising transmitting, by the device, the directory hierarchy via a plurality of metadata files.

5. The method of claim 1, further comprising encrypting, by the resource packager, the starting metadata file with a hash.

6. The method of claim 1, further comprising:
generating, by the resource packager, the one or more objects to identify a file extension for each of the one or more resources;
removing, by the resource packager, the file extension from each of the one or more resources; and
transmitting, by the device to the second device, the one or more resources without the file extension.

7. A method for receiving a file hierarchy using metadata, the method comprising:
receiving, by a device from a second device, a starting metadata file and one or more metadata files;
identifying, by a resource receiver of the device, from the starting metadata file, user credential information and an ordered list of one or more unique children identifiers corresponding to each of the one or more metadata files describing one or more sub-directories;
identifying, by the resource receiver, from one or more objects of the one or more metadata files, a parent identifier identifying the starting metadata file and the one or more sub-directories, the one or more sub-directories ordering one or more resources stored in the one or more sub-directories;
identifying, by the resource receiver, a directory hierarchy of the one or more sub-directories with the one or more resources; and
generating, by the resource receiver, the directory hierarchy using metadata from the starting metadata file and the one or more metadata files.

8. The method of claim 7, further comprising generating, by the resource receiver, a user interface to display the one or more sub-directories of the directory hierarchy.

9. The method of claim 8, further comprising displaying, by the resource receiver, in the user interface, the one or more resources stored in the sub-directory based on the ordered list.

10. The method of claim 8, further comprising:
receiving, by the device, a second set of one or more metadata files;
identifying, by the resource receiver, from the second set of one or more metadata files, a second set of one or more sub-directories based on a second set of unique child identifiers of the second set of one or more metadata files, the second set of one or more sub-directories ordering one or more resources stored in the second set of one or more sub-directories; and
displaying, by the resource receiver, in the user interface, the second set of the one or more sub-directories.

11. The method of claim 7, further comprising identifying, by the resource receiver, from the one or more objects of the one or more metadata files, a second ordered list of one or more unique identifiers of children directories to the sub-directory.

12. The method of claim 7, further comprising identifying, by the resource receiver, from the one or more objects of the one or more metadata files, a file name for each of the one or more resources.

13. The method of claim 7, further comprising identifying, by the resource receiver, the one or more objects encrypted by a hash.

14. The method of claim 7, further comprising identifying, by the resource receiver, the starting metadata file encrypted by a hash.

15. The method of claim 7, further comprising determining, by the resource receiver, the directory hierarchy according to the ordered list of the one or more unique children identifiers.

16. The method of claim 7, further comprising:
receiving, by the device from the second device, the one or more resources;
identifying, by the resource receiver, from the one or more metadata files, a file extension for each of the one or more resources; and
adding, by the resource receiver, the file extension to each of the one or more resources received by the device.

17. The method of claim 7, further comprising:
receiving, by the device, a second set of one or more metadata files;
identifying, by the resource receiver, from the second set of one or more metadata files, a second set of one or more sub-directories based on a second set of unique child identifiers of the second set of one or more metadata files, the second set of one or more sub-directories ordering one or more resources stored in the sub-directory;
generating, by the resource receiver, a comparison between the second set of one or more sub-directories to the one or more sub-directories;
identifying, by the resource receiver from the comparison, a sub-directory present in the one or more sub-directories but not in the second set of one or more sub-directories; and
removing, by the resource receiver from the device, each resource associated with the sub-directory.

18. The method of claim 17, further comprising:
generating, by the resource receiver, a user interface comprising the directory hierarchy; and
removing, by the resource receiver, the sub-directory and each resource associated with the sub-directory from the user interface.

19. The method of claim 7, further comprising:
receiving, by the device, at a first time, a first metadata file of the one or more objects;
identifying, by the resource receiver, in the first metadata file, a first resource of the one or more resources and a first parent identifier;
receiving, by the device, at a second time subsequent to the first time, a second metadata file of the one or more metadata files;
identifying, by the resource receiver, that the second metadata file corresponds to the first parent identifier and identifies a first sub-directory comprising a first child identifier corresponding to the first resource;
storing, by the resource receiver, based on the first child identifier and the first parent identifier, the first resource file in the first sub-directory.

20. The method of claim 19, further comprising displaying, by the resource receiver, in a user interface, the first resource file in the first sub-directory.
